(19) United States
(12) Patent Application Publication
(10) Pub. No.: US 2025/0060544 A1
(43) Pub. Date: Feb. 20, 2025

(54) FIBER-OPTIC BUNDLES FOR PARALLEL OPTICAL INTERCONNECTS

(71) Applicants: Howard Rourke, Sunnyvale, CA (US); Robert Kalman, Sunnyvale, CA (US); Alexander Tselikov, Sunnyvale, CA (US); Bardia Pezeshki, Sunnyvale, CA (US); Sunghwan Min, Sunnyvale, CA (US)

(72) Inventors: Howard Rourke, Sunnyvale, CA (US); Robert Kalman, Sunnyvale, CA (US); Alexander Tselikov, Sunnyvale, CA (US); Bardia Pezeshki, Sunnyvale, CA (US); Sunghwan Min, Sunnyvale, CA (US)

(21) Appl. No.: 18/760,883

(22) Filed: Jul. 1, 2024

Related U.S. Application Data
(60) Provisional application No. 63/524,130, filed on Jun. 29, 2023.

(51) Int. Cl. G02B 6/42; G02B 6/43

(52) U.S. Cl. CPC G02B 6/423; G02B 6/43

(57) ABSTRACT

A connector assembly for a fiber-optic bundle may provide for a ninety degree bend in the fiber-optic bundle. The connector assembly may be used in a microLED-based optical interconnect. The microLED-based optical interconnect may provide for data and/or clock communication from an array of microLEDs to an array of photodetectors, with a fiber-optic bundle providing an optical transmission medium coupling light between the microLEDs and the photodetectors. Fiber elements of the fiber-optic bundle may be bound together about ends of the fiber elements, but loose in an area of the bend.

### CROSS-REFERENCE TO RELATED APPLICATIONS

This application claims the benefit of U.S. Provisional Patent Application No. 63/524,130, filed on Jun. 29, 2023, the disclosure of which is incorporated by reference herein.

### BACKGROUND OF THE INVENTION

The desire for high-performance computing and networking is ubiquitous and seemingly ever-present. Prominent applications include data center servers, high-performance computing clusters, artificial neural networks, and network switches.

For decades, dramatic integrated circuit (IC) performance and cost improvements were driven by shrinking transistor dimensions combined with increasing die sizes, summarized in the famous Moore's Law. Transistor counts in the billions have allowed consolidation onto a single system-on-a-chip (SoC) of functionality that was previously fragmented across multiple ICs. However, the benefits of further transistor shrinks are decreasing dramatically as decreasing marginal performance benefits combine with decreased yields and increased per transistor costs. Independent of these limitations, a single IC can only contain so much functionality, and that functionality is constrained because the IC's process cannot be simultaneously optimized for different functionality, for example logic requires a different process than memory and high speed I/O. In fact, there are significant benefits to “de-integrating” SoCs into smaller “chiplets,” including: (1) the process for each chiplet can be optimized to its function; (2) chiplets are well-suited to reuse in multiple designs; and (3) chiplets are less expensive to design.

Chiplets have higher yield because they are smaller with fewer devices. However, a major drawback to chiplets compared to SoCs is that use of chiplets generally requires far more chip-to-chip connections. Compared to the on-chip connections between functional blocks in SoCs, chip-to-chip connections are typically much less dense and require far more power (for example normalized as energy per bit).

### BRIEF SUMMARY OF THE INVENTION

Some aspects provide a microLED-based communication system, comprising: an array of microLEDs; an array of photodetectors; and an optical-fiber bundle including a plurality of fiber elements, with first end faces of the fiber elements positioned to receive light generated by the array of microLEDs, and with a second end face of the fiber elements positioned to provide light to the array of photodetectors, the first end faces of the fiber elements fixed in position relative to one another, with the optical-fiber bundle having a 90 degree away from the end faces of the fiber elements, the fiber elements not fixed in position relative to one another within the 90 degree bend. Some aspects further comprise a connector housing a portion of the optical-fiber bundle about the first end faces of the fiber elements, with the optical-fiber bundle having a 90 degree bend within the connector. In some aspects the connector includes at least one alignment pin proximate to the first end faces of the fiber elements. Some aspects further comprise a ferrule, the ferrule configured to maintain the first end faces of the fiber elements fixed in position relative to one another. In some aspects the ferrule is within the housing. Some aspects further comprise a ferrule, the ferrule configured to maintain the first end faces of the fiber elements fixed in position relative to one another. Some aspects further comprise a portion of an assembly fixture, the portion of the assembly fixture configured to maintain the first end faces of the fiber elements fixed in position relative to one another. In some aspects the portion of the assembly fixture comprises a circumferential wall. In some aspects the first end faces of the fiber elements are fixed in position relative to one another by adhesive. Some aspects further comprise a frame, the frame configured to maintain the first end faces of the fiber elements fixed in position relative to one another. In some aspects the frame includes a circumferential wall, with the circumferential wall configured to maintain the first end faces of the fiber elements fixed in position relative to one another. In some aspects the frame includes a circumferential wall and interior walls extending between different sides of the circumferential wall, with the circumferential wall and the interior walls configured to maintain the first end faces of the fiber elements fixed in position relative to one another.

These and other aspects of the invention are more thoroughly comprehended upon review of this disclosure.

### BRIEF DESCRIPTION OF THE FIGURES

FIG. 1 is a block diagram of a communication channel of a parallel optical interconnect.

FIG. 2 illustrates an example optical coupling between a microLED array and a photodetector array, in accordance with aspects of the invention.

FIG. 3 shows a cross-section of an embodiment of a fiber bundle, in accordance with aspects of the invention.

FIG. 4 illustrates an example fiber bundle with packing segments about ends of the fiber-optic bundle, in accordance with aspects of the invention.

FIG. 5A illustrates a cross-section of a precision fixturing holding a plurality of fiber elements, in accordance with aspects of the invention.

FIG. 5B illustrates a cross-section of the plurality of fiber elements, after being positioned by the precision fixturing of FIG. 5A and adhered in relative position, in accordance with aspects of the invention.

FIGS. 6A-B show an end of a fiber-optic bundle mounted in a ferrule, in accordance with aspects of the invention.

FIGS. 7A-B show a top plan view and a slice cross-sectional side view of embodiments of an assembly fixture having posts and sidewalls for fiber positioning, in accordance with aspects of the invention.

FIGS. 8A-E illustrate views of frames for fiber positioning, in accordance with aspects of the invention.

FIG. 9 shows an example of a fiber bundle having a 90° bend.

FIG. 10 shows an example of bending of a fiber-optic bundle in which the cross-sectional shape of the fiber-optic bundle changes through a bend.

FIGS. 11A-B shows connector assemblies and fiber-optic bundle with a 90° bend, in accordance with aspects of the invention.

### DETAILED DESCRIPTION

Though optics has been a candidate for chip-to-chip interconnects for decades, coupling optical sources and detectors to waveguides may frequently dominate the cost of optical links and limits their density for this application.

Optical interconnects based on microLED (μLED) sources may offer a way to overcome some or all of the limitations described herein. In some embodiments, a microLED may be generally defined as an LED with a diameter of <100 μm in some embodiments, <20 μm in some embodiments, <4 μm in some embodiments, and <1 μm in some embodiments, and can be made with diameters <1 μm. In some embodiments the μLED sources can support optical links with lengths of >1m at >1 Gbps with lower drive power and very high density.

In some embodiments, a fiber-optic bundle is comprised of multiple optical fibers that are tightly packed in a two-dimensional (2D) bundle. They are well-suited to being used as a transmission medium short, highly parallel optical links, for instance for inter-IC interconnects.

In some embodiments, a fiber-optic bundle provides the transmission medium for an optical link for data communications between an optical transmitter and an optical receiver. In some embodiments, the optical transmitter includes an LED as a light source, in some embodiments the LED is a microLED. In some embodiments, the optical receiver comprises a photodetector. In some embodiments the microLED, coherent fiber bundle, and photodetector are within a same package for a multichip module. In some embodiments, the multichip module includes a plurality of semiconductor chips on a common substrate. In some embodiments, the optical transmitter is of a first chip of the plurality of semiconductor chips. In some embodiments, the optical receiver is of a second chip of the plurality of semiconductor chips. In some embodiments, the optical transmitter is of a first optical transceiver associated with a first chip of the plurality of semiconductor chips. In some embodiments, the optical receiver is of a second optical transceiver associated with a second chip of the plurality of semiconductor chips.

A parallel optical interconnect comprises a plurality of optical communication channels. In some embodiments, each communication channel comprises: an optical transmitter comprising a drive circuit electrically connected to an optical emitter (e.g. a microLED, LED or laser) that causes its input signal to be modulated onto the optical output of the emitter; input coupling optics that couple light from the emitter into an optical transmission medium; an optical transmission medium; at the other end of the optical transmission medium, output coupling optics that couple light to an optical receiver; an optical receiver comprising photodetector (PD) coupling optics, a PD, and a receiver circuit.

In some embodiments, the optical emitters are microLEDs made from direct gap semiconductors such as InGaN, InGaAlAs, InGaP, or InGaAsP. In some embodiments, the optical transmission medium for each channel comprises an optical waveguide, for instance an optical fiber or a planar optical waveguide.

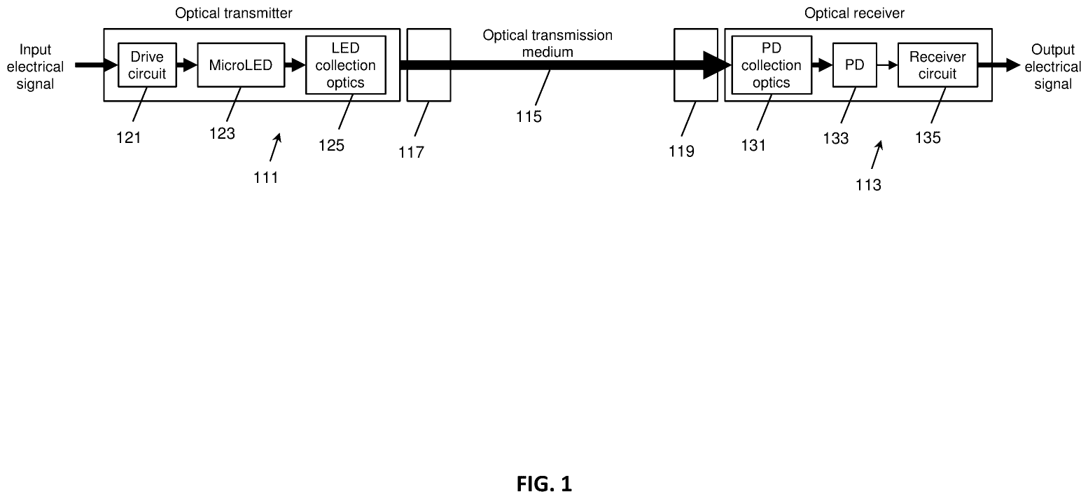

FIG. 1 is a block diagram of a communication channel of a parallel microLED optical interconnect. In some embodiments, each communication channel of a microLED optical interconnect comprises: an optical transmitter 111 comprising a microLED drive circuit 121 electrically connected to a microLED 123 that causes its input signal to be modulated onto the optical output of the microLED; microLED collection optics 125, input coupling optics 117 that couple light from the microLED into an optical transmission medium 115; the optical transmission medium; at the other end of the optical transmission medium, output coupling optics 119 that couple light to an optical receiver 113; the optical receiver comprising photodetector (PD) coupling optics 131, a PD 133, and a receiver circuit 135. In some embodiments, the optical transmission medium for each channel comprises an optical waveguide, for instance an optical fiber or a planar optical waveguide. In some embodiments the microLED collection optics and the input collecting outputs are combined into a single device, for example a lens. In some embodiments the microLED collection optics and the input collecting optics are omitted, for example with a fiber of the optical transmission medium butt-coupled to the microLED. Similarly, in some embodiments the PD collection optics and the output collecting outputs are combined into a single device, for example a lens. In some embodiments the PD collection optics and the input collecting optics are omitted, for example with a fiber of the optical transmission medium butt-coupled to the PD.

In some embodiments, a parallel optical interconnect comprises an array of emitters, input coupling optics, a transmission medium, output coupling optics, and an array of photodetectors (PDs). In some embodiments, there are no input and output coupling optics, and the emitter and PD arrays are butt-coupled to the transmission medium.

In some embodiments, the array of emitters and the array of PDs are located on some regular grid. In some embodiments, the emitter and PD grids are hexagonal close-packed (HCP), square, or rectangular grids. In some embodiments, the center-to-center spacing of grid elements are in the range of 10 μm-100 μm.

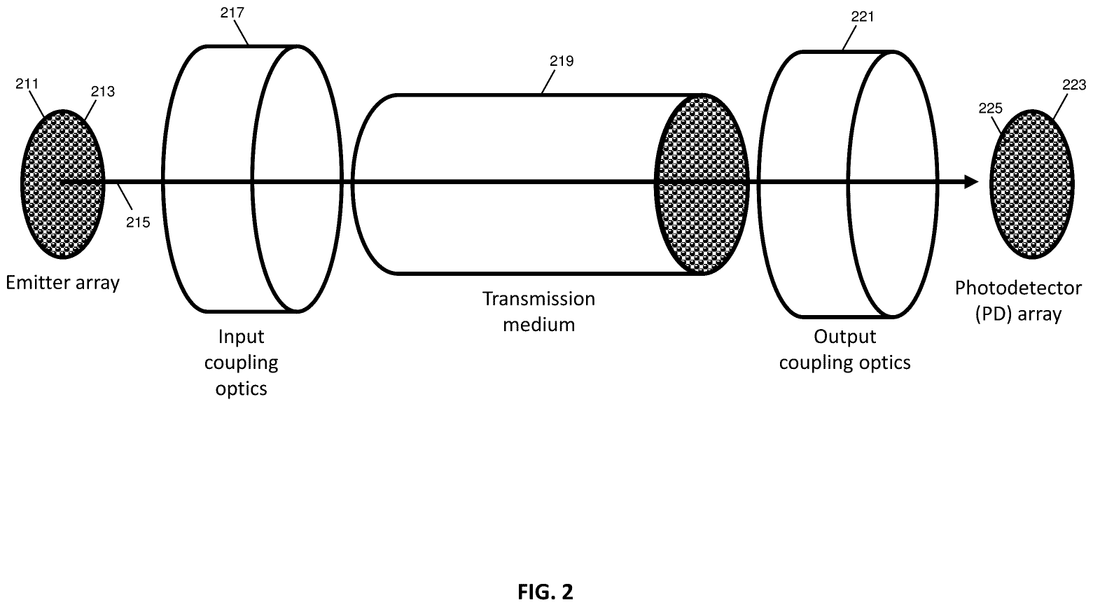

FIG. 2 illustrates an example optical coupling between a microLED array and a photodetector array. In some embodiments the example of FIG. 2 may be considered one direction of a bi-directional duplex parallel optical interconnect. A corresponding parallel reverse-direction example (not shown in FIG. 2) may provide the other direction of the bi-directional duplex parallel optical interconnect.

In FIG. 2, an emitter array 211 includes a plurality of microLEDs, for example microLED 213. The microLEDs can be considered an array of microLEDs. In FIG. 2, the plurality of microLEDs are shown as arranged to fill a circular area. In some embodiments the microLEDs may fill a hexagonal area, a rectangular area, or some other area. In some embodiments, the microLEDs are arranged in a grid. In some embodiments the grid is a hexagonal close-packed (HCP) grid, a square grid, or a rectangular grid. In some embodiments, the center-to-center spacing of grid elements are in the range of 20 μm-100 μm.

Input coupling optics 217 couples light 215 from the emitter array with a transmission medium 219. In some embodiments the input coupling optics may be omitted. For example, in some embodiments the transmission medium may be butt-coupled to the emitter array instead. In some embodiments the input coupling optics comprises one or more lenses and/or one or more mirrors. In some embodiments there is a lens for each microLED in the array of microLEDs. In some embodiments there is a single lens for all of the microLEDs in the array of microLEDs. In some embodiments there is a pair of lenses for all of the microLEDs in the array of microLEDs.

In some embodiments the optical transmission medium 219 comprises optical fibers. In some embodiments the optical fibers are arranged in a optical-fiber bundle. In some embodiments the fiber bundle is a coherent fiber bundle, with fibers of the optical-fiber bundle having the same relative arrangement to one another at each end of the fiber bundle. In some embodiments the optical-fiber bundle contains a plurality of fiber sub-bundles. In some embodiments each of the fiber sub-bundles is coherent, but the fiber bundle as a whole is not coherent. In some embodiments the optical transmission medium comprises a plurality of fiber bundles. In some embodiments light from each microLED of the microLED array is carried by a single fiber. In some embodiments light from each microLED is carried by a plurality of fibers.

In FIG. 2, light from the microLEDs passed through the optical transmission medium is coupled to a plurality of photodetectors by optional output coupling optics 221. The photodetectors may be considered an array of photodetectors. The output coupling optics, like the input coupling optics, may comprise comprises one or more lenses and/or one or more mirrors. In some embodiments there is a lens for each photodetector in the array of photodetectors. In some embodiments there is a single lens for all of the photodetectors in the array of photodetectors. In some embodiments there is a pair of lenses for all of the photodetectors in the array of photodetectors, for example with a lens on either side of a turning mirror of the input coupling optics. In some embodiments there is a lens for each photodetector in the array of photodetectors between the photodetectors and a turning mirror, and a single lens between the turning mirror and the transmission medium.

In FIG. 2, the plurality of photodetectors are shown as arranged to fill a circular area. In some embodiments the photodetectors may fill a hexagonal area, a rectangular area, or some other area. In some embodiments, the photodetectors are arranged in a grid. In some embodiments the grid is a hexagonal close-packed (HCP) grid, a square grid, or a rectangular grid. In some embodiments, the center-to-center spacing of grid elements are in the range of 20 μm-100 μm. In some embodiments there is a one-to-one correspondence between photodetectors and microLEDs.

In some embodiments of a parallel optical interconnect, the transmission medium comprises an array of optical fibers (a fiber “bundle”) or an array of optical waveguides. A fiber-optic bundle comprises multiple fiber elements. In some embodiments, each fiber element comprises a core surrounded by a concentric cladding layer with a lower index of refraction than the core, enabling the guiding of light in the core. In some embodiments, all fiber elements have the same nominal dimensions and properties. In some embodiments, the outside of each fiber element may be coated with a “lubricant” material that reduces friction between the fiber elements. Reducing friction between fiber elements is desirable to decrease the chance of breaking fiber elements as the fiber-optic bundle is assembled and moved during use.

In some embodiments, the space between fiber elements is filled by a filler material such as polymer or glass. In some embodiments, there is no filler material between fiber elements. In some embodiments, the filler material is the same as the fiber element cladding material. In some embodiments, the filler material may be highly optically absorbing to attenuate any light not propagating in fiber element cores.

In some embodiments, each fiber element is a single-mode fiber. In some embodiments, each fiber element is a multimode fiber. Multimode fibers may be preferred for use with microLED and LED sources as multimode fibers allow for greater coupling of light from microLEDs than for single-mode fiber. The numerical aperture (NA) of a fiber is defined as NA=sin(θ_{c}), where θ_{c} is the maximum external acceptance angle of the fiber (relative to the fiber's propagation axis); rays at angles larger than θ_{c} are not guided by the fiber.

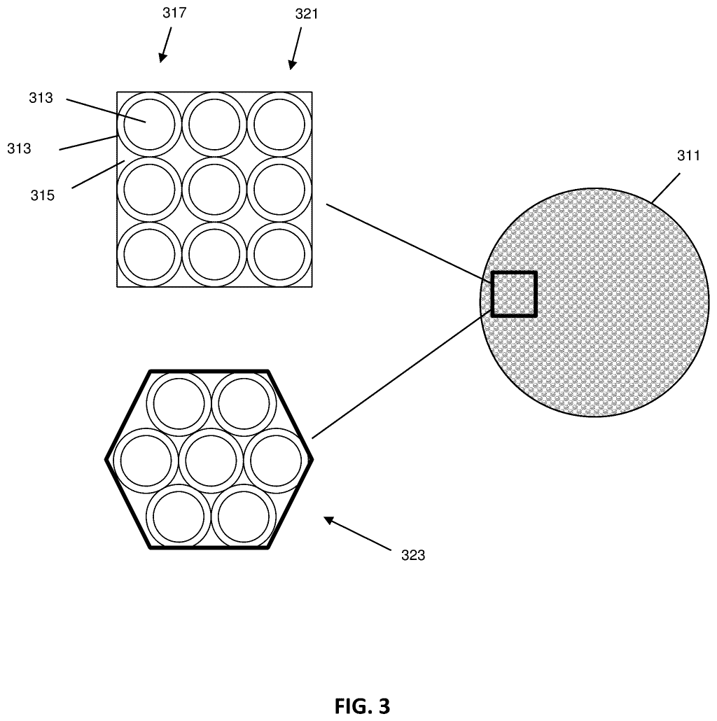

A cross-section of an embodiment of a fiber-optic bundle 311 is shown in FIG. 3. The coherent fiber bundle includes a plurality of cores 313 for the transmission of light. Each core is surrounded by a concentric cladding layer 313 that has a lower index of refraction than the core. Each core and corresponding concentric cladding layer together may be considered a fiber element 317. In some embodiments, the fibers may be arranged in a regular pattern, such as on a square grid 321 or hexagonal grid 323.

In some embodiments, of a fiber-optic bundle, the positions of each fiber element relative to the other fiber elements is the same at each packing segment such that the fiber element positions are not “mixed” at each packing segment. A fiber-optic bundle in which the relative positions of the fiber elements are preserved is referred to as a “coherent” fiber-optic bundle. In some embodiments, the grid pattern of the fiber elements in a fiber-optic bundle matches that of the emitter array and PD array elements. In some embodiments, the fiber elements are on a finer grid than the emitter and PD array elements such that each emitter and PD couples to more than one fiber element in the fiber-optic bundle.

In some embodiments, fiber elements of different diameters may be used to improve packing density. In some embodiments of a fiber-optic bundle, each fiber element has a diameter in the range of 25 μm to 100 μm, where some fiber elements may have a larger diameter within such range when compared to other fiber elements. In some embodiments, the larger diameter fiber elements and the smaller diameter fiber elements may alternate in the square or hexagonal grid pattern described herein. In some embodiments of a fiber-optic bundle, each fiber element has a diameter of greater than 100 μm. In some embodiments, there are 100 or fewer fiber elements making up the fiber-optic bundle. In some embodiments, there are more than 100 fiber elements making up the fiber-optic bundle.

In some embodiments of a fiber-optic bundle, packing segments may comprise fiber elements on a regular grid (e.g., a hexagonal or square grid), but where one or more grid elements are omitted. Elements may be omitted, for instance, due to the use of assembly fixturing intended to improve the positioning accuracy of the fiber elements, which make up the fiber-optic bundle, relative to the emitter and receiver arrays and also to the coupling optics.

Desirable attributes for fiber-optic bundles may include: (1) accurate positioning of each fiber element relative to some desired grid, or accurate positioning of ends of each fiber element relative to the desired grid; (2) high packing density of fiber elements, typically defined as the fraction of the fiber-optic bundle end face area occupied by fiber elements; (3) robustness over various environmental conditions and time; and (4) low cost.

In some embodiments, as indicated above, circular cross-section fiber elements of uniform diameter may be packed in a square grid or a hexagonal close-packed (HCP) grid configuration with adjacent fiber elements being in contact with each other; this configuration with adjacent fiber elements touching may be referred to as “tight-packed”. In real fiber-optic bundles, there is some variance in the fiber element diameters even if all fiber elements have the same nominal diameters. When such fiber elements are assembled into a tight-packed fiber-optic bundle (e.g., in a square or HCP grid configuration), the variance in the individual fiber element diameters may result in the positions of fiber elements having errors relative to their ideal desired positions, with this fiber element positioning error increasing as the number of elements in the bundle increases. This fiber element positioning error is undesirable because it increases losses in coupling to arrays of optical emitters and detectors, and in fiber-optic connectors where one fiber-optic bundle is connected to another.

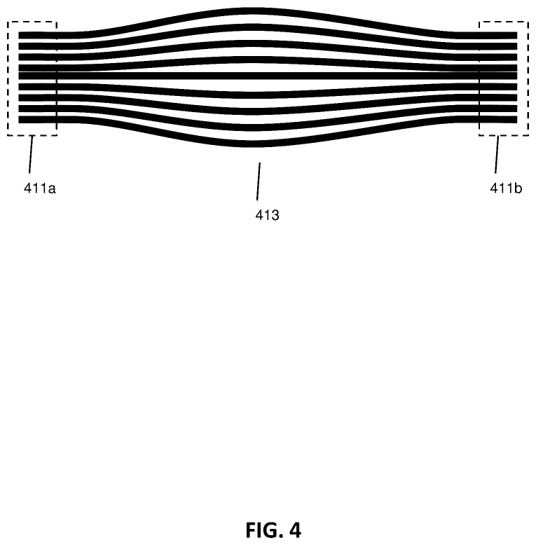

A large number of fiber elements may be packed together in a fiber-optic bundle. In some embodiments, the fiber elements may be packed together only in certain “packing segments” along the length of the fiber-optic bundle, e.g. at the fiber-optic bundle end faces, with the fiber elements being allowed to float loosely between those packing segments. FIG. 4 illustrates an example fiber bundle with packing segments about ends of the fiber-optic bundle. In FIG. 4, a fiber-optic bundle 413 includes a plurality of optical fibers. Optical fibers at opposing ends 411a, 411b of the fiber-optic bundle are held closely together. In some embodiments the optical fibers at the opposing ends may be held closely together by a ferrule, for example, or some other structure to hold the optical fibers packet together in a fixed arrangement. In some embodiments, the fiber elements may be packed along the entire length of the fiber-optic bundle, i.e., the fiber-optic bundle comprises a single extended packing segment. In the sections of fiber-optic bundles between packing segments in which the fiber elements float loosely, the fiber-optic bundle may be be bent with a much smaller radius than in the packing segments because the bending radius is limited by diameter of individual fiber elements rather than by the diameter of the entire fiber-optic bundle. By contrast, the bend radius in packing segments may be limited by the diameter of the entire fiber-optic bundle, which is typically many times larger than the diameter of individual fiber elements.

In some embodiments, fiber elements are assembled into a fiber-optic bundle using precision fixturing that defines the outer dimensions of the fiber-optic bundle very precisely defined by the fixturing. In some embodiments, the precision fixturing may have a cross-sectional opening in the middle of its body where fiber elements are inserted within such opening to form into a specific packing grid, such as a square or HCP grid configuration. Consequently, the cross-sectional opening may be square or hexagonal shaped. In some embodiments, after the fiber elements are assembled in the desired manner, the fiber elements may be permanently affixed to each other, for example using an adhesive.

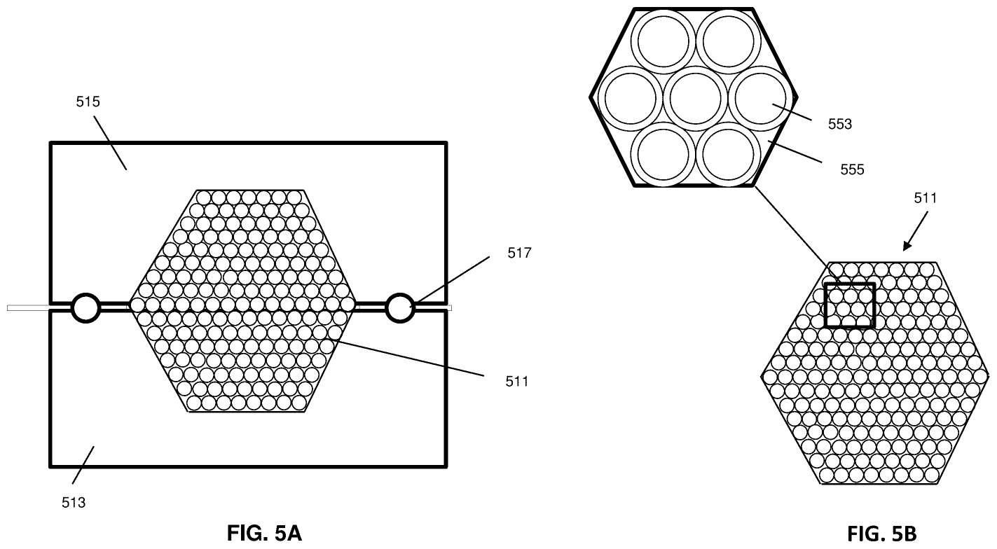

In some embodiments, the precision fixturing may come in multiple parts. FIG. 5A illustrates a cross-section of a precision fixturing holding a plurality of fiber elements. In some embodiments, and as illustrated in FIG. 5, a body of the precision fixturing may be divided into two parts along the cross-sectional opening so as to have a top fixture component 515 and a bottom fixture component 513. In some embodiments, the top fixture component and the bottom fixture component may be symmetric to each other and each may define a half of a cross-sectional opening. Optical fibers of a fiber bundle 511 extend through the opening. The size of the cross-sectional opening may be set to tightly pack a predetermined number of optical fibers of a known diameter, or of a known average diameter. In some embodiments, the fiber elements that make up a fiber-optic bundle may be sorted by size such that they are assembled into a fiber-optic bundle in a way that minimizes fiber element positioning error. For instance, fiber elements in a fiber-optic bundle may be selected such that, if a first fiber element has a diameter larger than the ideal nominal value, an adjacent second fiber element has a diameter smaller than the ideal value such that the mean of the diameters of the first fiber element and second fiber element is close to the nominal value.

In some embodiments, the top fixture component may be separated from the bottom fixture component to allow for a more convenient placement of the fiber elements in the cross-sectional opening for packing into a desired grid configuration of a fiber-optic bundle, with the top fixture component brought close to or in contact with the bottom fixture component after the fiber elements are positioned in or about the opening.

In some embodiments, and as illustrated in FIG. 5A, there may exist one or more alignment pins, for example two alignment pins, e.g., alignment pin 517, between the contact surfaces of the top and the bottom fixture components. In some embodiments, the alignment pins may accurately align the top and bottom fixture components together to ensure the cross-sectional opening has the correct shape to form the fiber-optic bundles into the correct fiber-optic bundle grid configuration. In some embodiments, the precision fixturing may stay attached to the ends of the fiber bundle after the formation of the fiber-optic bundle. In such case, the alignment pins may be used to align and couple the ends of the fiber-optic bundle with the emitter and detector arrays, the coupling optics, or another fiber-optic bundle.

In some embodiments the fiber-optic bundle may be removed from the precision fixturing, for example after fiber elements of the fiber-optic bundle are adhered in relative position to one another. FIG. 5B illustrates a cross-section of the plurality of fiber elements, after being positioned by the precision fixturing of FIG. 5A and adhered in relative position. As illustrated in FIG. 5B, fiber elements 553 of the fiber-optic bundle 511 may be maintained in relative position, for example in a hexagonal tightly packed grid, using an adhesive 555.

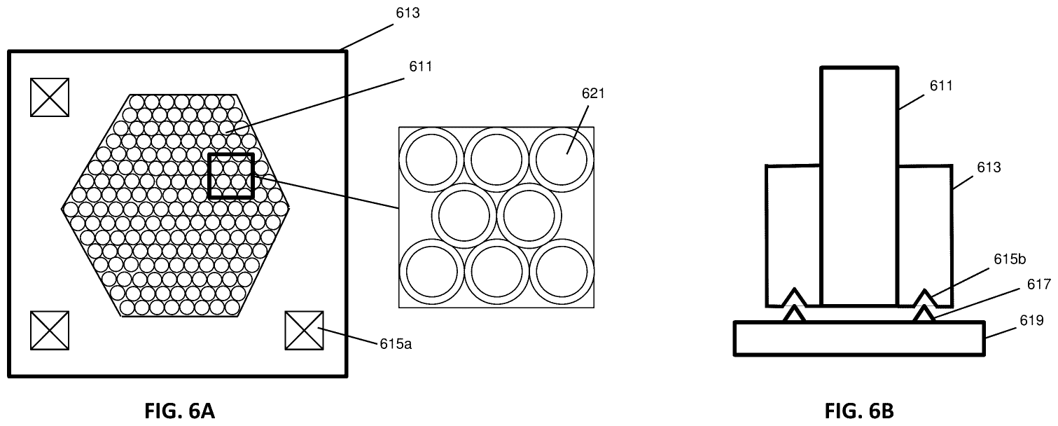

In some embodiments, fiber elements are assembled into a fiber-optic bundle using a ferrule with a cross-sectional opening that precisely defines the outer dimensions of the fiber-optic bundle. In some embodiments the ferrule may also be used as a precision fixturing, for example the precision fixturing of FIG. 5A. FIG. 6A shows an end face of a fiber-optic bundle mounted in a ferrule, with FIG. 6B showing a cross-sectional side illustrating aspects of use of an example alignment feature of the ferrule. In FIG. 6A, the ferrule 613 has a fiber-optic bundle 611 in a opening through the ferrule, with the ferrule latitudinally encompassing the fiber-optic bundle about its end. The fiber-optic bundle includes a plurality of fiber elements, for example fiber element 621. In some embodiments, the opening of the ferrule could have a tapered section along its length which, like a funnel, would guide the fibers into the very precise hexagonal or square cross-sectional hole. After the fiber elements are pushed through into this precise hole and assembled in the desired manner, fiber elements may be permanently affixed to each other and to the ferrule using an adhesive. The end face of the fiber-optic bundle may then be polished such that the fibers all terminate on a plane.

The ferrule may comprise additional features allowing it to be accurately aligned to other structures such as a transmitter array, receiver array, coupling optics, or another fiber-optic bundle. In some embodiments, some outer surfaces of the ferrule may have high accuracy with respect to inner ferrule surfaces such that aligning an external structure to those outer surfaces ensures alignment with high accuracy to the inner surfaces. In some embodiments, the end face of the ferrule has a well-defined location relative to the end faces of the individual fiber elements making up the fiber-optic bundle, and the ferrule end face additionally comprises visual fiducial features and/or mechanical keying features that are aligned with high accuracy to the opening in the ferrule end-face. The visual fiducial features and/or mechanical keying features may be used in aligning and coupling the fiber-optic bundle with emitter and detector arrays, coupling optics, or another fiber-optic bundle. FIG. 6A shows an example of positioning of visual fiducial features, e.g., visual fiducial feature 615a on or as part of the ferrule end face. Some examples of mechanical key features are precision depressions, raised features, and alignment pins. FIG. 6B shows the fiber bundle mounted in the opening of the ferrule 613, with a mechanical keying feature in the form of a depression 615b. The depression may be mated with a corresponding raised feature 617 on a mounting surface 619. In some embodiments, the substrate or the component that the ferrule is designed to be aligned and coupled with may have opposite mating mechanical key features corresponding to the key features of the ferrule.

In some set of embodiments, a fiber-optic bundle is assembled from fiber elements using an assembly fixture where the end faces of fiber elements are in contact with the fixture base, and some of the fiber elements are excluded from certain raised regions that are raised above the base. These raised regions may be in the form of posts having precision sidewalls such that fiber elements in contact with the sidewalls are positioned around the posts and in the desired packing position with great accuracy. Through the use of these precision raised regions (e.g., posts), any accumulated positioning error across a bundle of fiber elements is “reset” by the very accurate sidewall locations of the posts. Increasing the number of raised posts may reduce fiber element positioning errors but at the expense of decreasing mean fiber-optic bundle packing density because fiber elements are excluded from where the raised posts are located. This may result, for instance, in a fiber-optic bundle with fiber elements accurately positioned on a regular square or hexagon grid but with some omitted fiber elements in the raised areas of the assembly fixture. In some embodiments, the raised posts may be symmetrically spaced apart along the base of the assembly fixture in rows and columns.

The assembly fixture may also comprise precision raised outer wall regions surrounding where the fiber elements would be located that accurately constrain the location of fiber elements along the outer edge of the fiber-optic bundle. In some embodiments, the outer wall region may form a rectangular, hexagonal, or circular shape. After the fiber elements are positioned using the assembly fixture, they are fixed in place, for instance using an adhesive such that the fiber elements of the fiber-optic bundle maintain their relative positions. In some embodiments, the fiber-optic bundle is removed from the assembly fixture after fixing the fiber elements in place. In some embodiments, only the base plate of the assembly fixture is removed and the raised posts and outer walls remain attached to the fiber-optic bundle to aid in aligning and coupling the fiber-optic bundle with the emitter and detector arrays, coupling optics, or another fiber-optic bundle. In some embodiments, the top edges of the raised posts may comprise a sharp edge or point that helps direct the fiber elements incident on the regions toward the sidewalls of the raised posts.

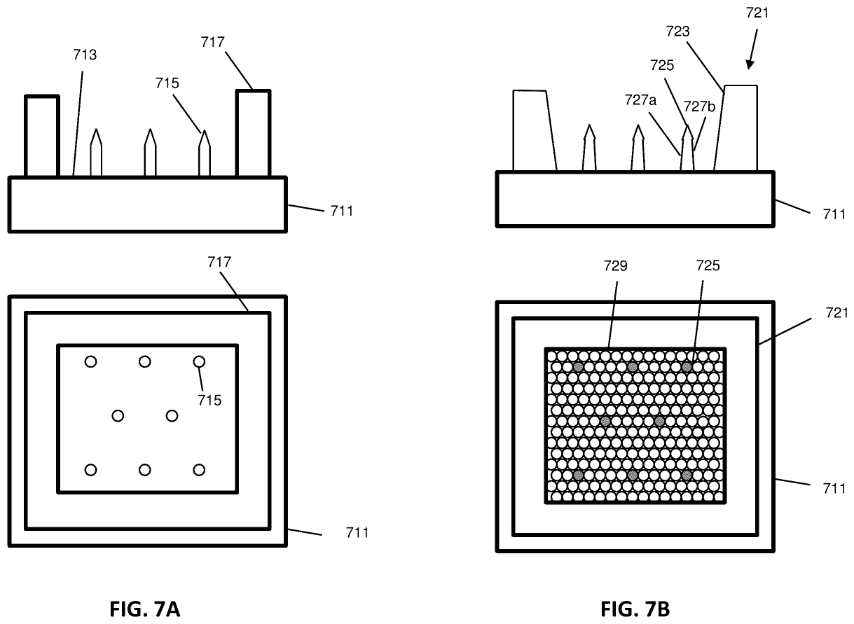

FIG. 7A shows a top plan view and a slice cross-sectional side view of an embodiment of an assembly fixture having posts and sidewalls for fiber positioning. The assembly fixture includes a base plate 711. The base plate is shown as having a top surface defining a square area. In various embodiments the top surface may define other shapes. A raised wall 717 extends from the top surface of the base plate, about a circumference of the base plate. The raised wall generally defines a volume for receiving ends of fiber elements above or on the top surface of the base plate. Raised posts 715 also extend from the top surface of the base plate, within the circumference of the raised wall. The raised posts may be cylindrical in shape, or, as illustrated in FIG. 7A, have a cylindrical base and a conical top. In some embodiments the raised posts have a cross-section equivalent to one or more fiber elements, for example between one to eight fiber elements.

In some embodiments, the raised wall and post regions may have tapered sidewalls such that the cross-section of these regions is largest at the base and tapers moving away from the base. FIG. 7B shows a top plan view and a slice cross-sectional side view of an embodiment of an assembly fixture having tapered posts and sidewalls for fiber positioning. The embodiment of FIG. 7B is similar to that of FIG. 7A. In FIG. 7B, however, the raised circumferential wall 721 includes a sloping surface 723 on a side of the wall towards the interior volume for receiving ends of the fiber elements. Positioning of the ends of the fiber elements 729 also shown in FIG. 7B. The sloping surface provides the wall lesser width at a top of the wall than at the bottom, easing insertion of the ends of the fiber elements into the volume for receiving those ends. The raised posts 725 also have sloping surfaces 727a,b (in cross-sectional view, for conic raised posts the sloping surface may be a single sloping circumferential surface). The sloping surface(s) extend from a bottom of top conical surface, and extend towards the base with increasing diameter. The sloping surface of the raised posts may also ease insertion of the ends of the fiber elements into the volume for receiving those ends.

During assembly of the fiber-optic bundle, the fiber elements may be progressively inserted into the assembly fixture until there is no more room for additional fiber elements. In some embodiments, the raised regions (e.g., the posts and walls) may be fabricated from “hard” materials with limited elasticity such as silicon or steel. In some embodiments, the walls and posts of these raised regions may comprise a layer of a material with significant elasticity, such as an elastomer, that enable a controlled amount of force to be exerted against the sides of the fiber elements due to compression of the elastic layer. In some embodiments, some of the raised regions such as the edge wall regions may incorporate springs or other flexible elements that produce a force pushing against the sides of the fiber elements, leading to good packing of the fiber elements by eliminating gaps between fiber elements. In some embodiments the base plate is removed after insertion of the fiber elements into the assembly fixture, with the circumferential wall (and possibly the raised regions) holding the fiber element end faces in relative position to one another.

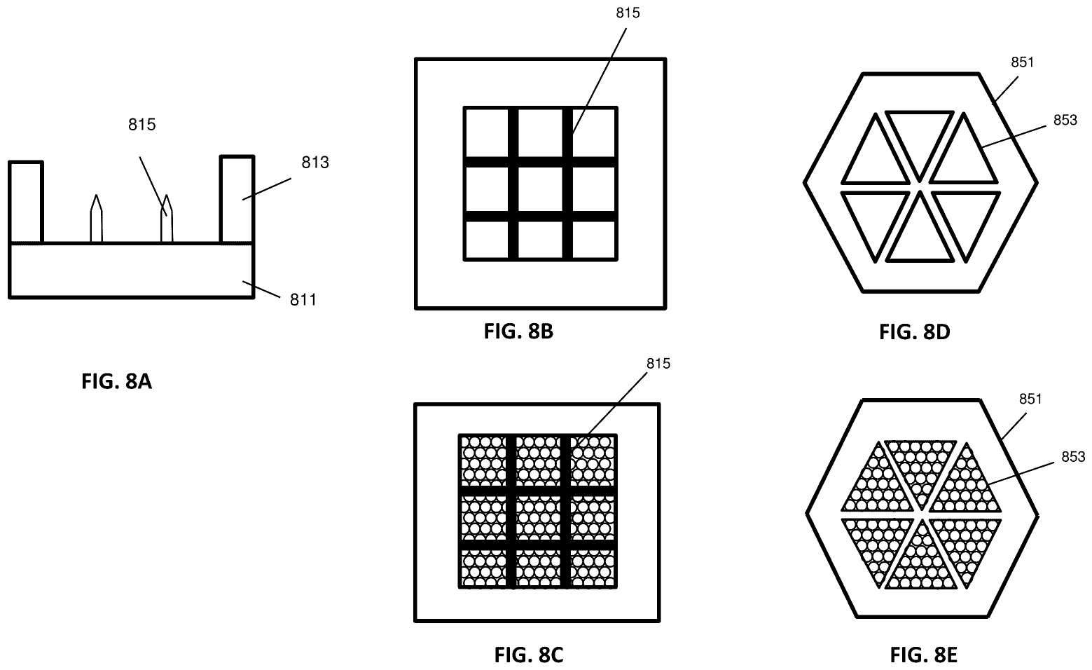

In some embodiments, a fiber-optic bundle is assembled from fiber elements using a “frame” that includes inner walls and outer walls that separate the fiber-optic bundle into multiple sub-bundles. FIG. 8A shows a cross-sectional slice of a frame that includes walls for separating fiber-optic element ends into sub-bundles. FIG. 8B shows a top plan view of the frame of FIG. 8A, and FIG. 8C shows the same top plan view along with general positioning of the ends of the fiber elements. The frame of FIGS. 8A-C include a base plate 811. Exterior circumferential walls 813 extend from a top surface of the base plate, around a circumference of that top surface. In the embodiment of FIGS. 8A-C, the top surface of the base plate has a square shape, in various embodiments the top surface may have different shapes. Interior walls, for example interior wall 815, extend between opposing sides of the exterior circumferential wall. The interior walls and exterior circumferential wall together define volumes for receiving ends of fiber elements of a fiber-optic bundle. In some embodiments, each of the volumes may be considered to receive ends of a sub-bundle of the fiber-optic bundle. In some embodiments, the outer and inner walls may be on a base plate where the end faces of the fiber elements are designed to be inserted between the walls and contact such base plate. In some embodiments, the outer walls may surround the exterior fiber elements and form an enclosure around the end face of the fiber-optic bundle. In some embodiments, the outer walls may form a rectangular, hexagonal, or circular enclosure around the fiber elements. In some embodiments, the outer walls may form a square shape and the inner walls may divide the inserted fiber elements in square sub-bundles. Consequently, some of the inner walls may be a plurality of columns extending across the cross-sectional opening of the assembly fixture connecting the outer walls that are opposite to each other, and some of the inner walls may be a plurality of rows extending across the cross-sectional opening of the assembly fixture connecting the outer walls that are opposite to each other. In some embodiments, the columns and rows of inner walls may from a square tic-tac-toe grid. In some embodiments, the columns and rows of inner walls may divide the fiber elements in a range of 3 by 3 to 8 by 8 square sub-sections. In some embodiments, the outer walls may form a hexagonal shape and the inner walls may divide the inserted fiber elements in triangular sub-bundles. For example, FIGS. 8D-E show a top plan view of a frame with outer walls 851 forming a hexagonal shape and inner walls 853 dividing the hexagonal shape into triangular shapes. FIG. 8D shows the frame, while FIG. 8E shows the frame and positioning of ends of fiber elements. In some embodiments, the hexagonal edges formed by the outer walls that are opposite to each other may be connected to each by the inner walls extending from one opposite edge, to the middle of the hexagon, and to the opposite hexagonal edge. Consequently, six triangular sub-bundles may be formed by the inner walls for the fiber elements to be inserted thereto.

As is the case with the end face fixtures described herein, the wall regions may provide accurate locations to the adjacent fiber elements that are in contact with the walls. Thus, any accumulated positioning error across a bundle of fiber elements may be “reset” by the very accurate position of both inner and outer walls. Increasing the number of inner walls can reduce fiber element positioning errors at the expense of decreasing mean fiber-optic bundle packing density because fiber elements are excluded from the inner wall regions. After the fiber elements are positioned in the frame, they may be fixed in place, for instance using an adhesive. In some embodiments, the frame remains as a permanent part of the bundle after manufacturing. In some embodiments, the base plate is removed but the walls remain attached to the fiber-optic bundle. In some embodiments, the assembly fixture is completely removed from the fiber-optic bundle after the fiber elements are fixed into place with each other.

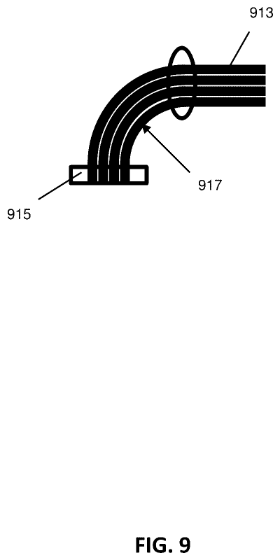

In some embodiments, a fiber-optic bundle comprises a region where the fiber elements in the fiber-optic bundle are bent along their lengths such that the fiber-optic bundle as a whole is bent through some angle, in some cases an angle of 90°. FIG. 9 shows an example of a fiber bundle 913 having ends in a ferrule 915 and having a 90° bend 917. If the fiber elements are not rigidly held to each other in the bent region, the fiber-optic bundle may be bent at a bend radius limited by the bend radius of each individual fiber element. Each fiber element has a diameter that is typically far smaller than the diameter of the fiber-optic bundle as a whole. Because bend radius is generally proportional to diameter, the portion of the fiber elements held loosely together may allow the fiber-optic bundle to be bent at a small bend radius, e.g., 2-4 mm. The ability to bend a fiber-optic bundle at a small bend radius may allow a fiber-optic bundle with a 900 bend to be used in applications with highly constrained space, for instance in pluggable optical modules or for optical links that are co-packaged with high-performance ICs.

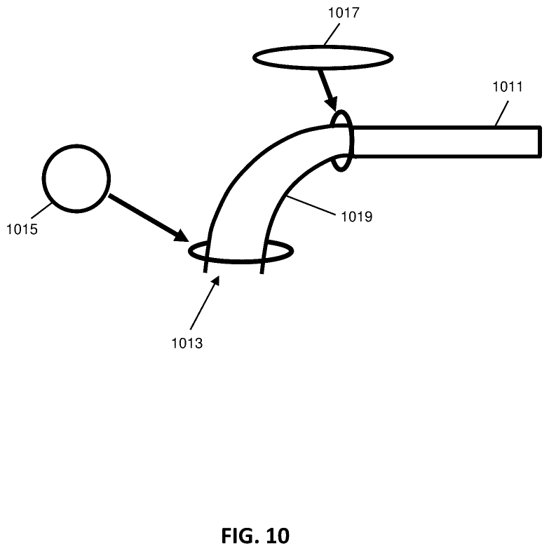

In some embodiments, the cross-sectional shape of the fiber-optic bundle is maintained through the bent section. In some embodiments, the cross-sectional shape of the fiber-optic bundle changes through the bend. FIG. 10 shows an example of bending of a fiber-optic bundle in which the cross-sectional shape of the fiber-optic bundle changes through a bend. In FIG. 10, a fiber-optic bundle 1013 has a circular cross-section 1015 away from a 90° bend in the bundle. In the 90° bend, an inner fiber bend radius 1019 is less than an outer bend radius, in the bundle. In the bend, the bundle has an elliptical cross-section 1017. In some embodiments, the outline of the cross-section of the fiber-optic bundle may be nominally circular or hexagonal at the bundle end-face and transition smoothly to an elliptical or elongated hexagonal shape in the bend. In some embodiments, the smooth transition in cross-sectional shape may be due to the fiber elements being loosely held together at the transition point into the bend, and the transition point may be away from the packing segments and the end faces of the fiber-optic bundle. Alternatively, the fiber elements may be held together tightly (i.e., rigidly or semi-rigidly) at such a transition point. Such a transition in the cross-sectional shape of the bundle may provide flexibility in routing of individual fiber elements such that, for instance, the minimum radius of curvature across all fiber elements is increased. Increasing the minimum radius of curvature may be preferred because fiber elements typically experience a significant increase in probability of breaking below some minimum bend radius.

In some embodiments, the bent section of the fiber-optic bundle may be embedded in a filler material such as an adhesive such that the spaces between the fiber elements are filled with the material, while other embodiments, the spaces between fiber elements may not be filled.

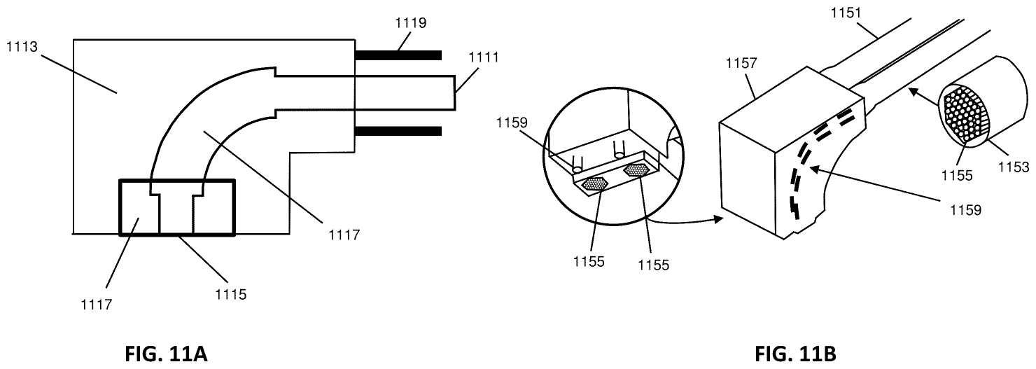

In some embodiments, the bent section of a fiber-optic bundle may be part of a connector assembly that includes the fiber-optic bundle end-face and ferrule. FIG. 11A shows a side cross-section of a connector assembly and fiber-optic bundle with a 900 bend, while FIG. 11B shows an exploded view of a practical application of the connector assembly. In FIG. 11A, fiber elements of a fiber-optic bundle 1111 have end faces 1115 held tightly together by a ferrule 1117. The ferrule is shown in FIG. 11A as within a housing provided by a connector assembly 1113, although in some embodiments the ferrule may be outside the housing, for example near or adjacent the housing. Within the housing of the connector assembly, the fiber-optic bundle has a 90° bend 1117. The fiber-optic bundle exits the housing after the bend, with a fiber cable casing 1119 covering the fiber-optic bundle outside the connector assembly. The connector assembly may support features such as locking of the connector to other structures and interfacing to cable housing for the bundle. In some embodiments, the connector is used as an in-line connector that mates to another similar connector and fiber bundle. In some embodiment, the connector is used to couple a fiber-optic bundle to a transmitter and/or receiver assembly, for example the optical transmitter or optical receiver of FIG. 1. Thus the small diameter of the individual fiber element allows a tight bending radius and may therefore eliminate a need for free-space optics, mirrors, or other methods of bending the light in a 90° connector. FIG. 11B shows a practical implementation of this approach with two fiber-optic bundles in a plastic connector, one for fiber-optic bundle for transmit and another for receive. In FIG. 11B, the fiber-optic bundles are in a casing 1151 outside of a connector 1157. Each of the fiber-optic bundles may be in their own casing 1153, with the fiber-optic bundles having a plurality of fiber elements 1155. Within the connector, the fiber elements undergo a 900 bend 1159, with end faces of the fiber elements exposed out of the connector. In FIG. 11B, the end faces of each of the fiber-optic bundles are arranged on a hexagonal grid 1155, 1156. In some embodiments, and as illustrated in FIG. 11B, the connector has two alignment pins placed proximate to the end faces of the two fiber-optic bundles. In various embodiments, the number of alignment pins may vary. The alignment pins assist in proper mating of the connector into an appropriate receptacle. Except for the small height of the connector, the bent fiber in the connector allows the fibers to exit horizontally, with the end faces positioned vertically.

Although the invention has been discussed with respect to particular embodiments, it should be recognized that the invention comprises the novel and unobvious claims supported by this disclosure.

What is claimed is:

1. A microLED-based communication system, comprising:
an array of microLEDs;
an array of photodetectors; and
an optical-fiber bundle including a plurality of fiber elements, with first end faces of the fiber elements positioned to receive light generated by the array of microLEDs, and with a second end face of the fiber elements positioned to provide light to the array of photodetectors, the first end faces of the fiber elements fixed in position relative to one another, with the optical-fiber bundle having a 90 degree away from the end faces of the fiber elements, the fiber elements not fixed in position relative to one another within the 90 degree bend.

2. The microLED-based communication system of claim 1, further comprising a connector housing a portion of the optical-fiber bundle about the first end faces of the fiber elements, with the optical-fiber bundle having a 90 degree bend within the connector.

3. The microLED-based communication system of claim 2, wherein the connector includes at least one alignment pin proximate to the first end faces of the fiber elements.

4. The microLED-based communication system of claim 2, further comprising a ferrule, the ferrule configured to maintain the first end faces of the fiber elements fixed in position relative to one another.

5. The microLED-based communication system of claim 4, wherein the ferrule is within the housing.

6. The microLED-based communication system of claim 1, further comprising a ferrule, the ferrule configured to maintain the first end faces of the fiber elements fixed in position relative to one another.

7. The microLED-based communication system of claim 1, further comprising a portion of an assembly fixture, the portion of the assembly fixture configured to maintain the first end faces of the fiber elements fixed in position relative to one another.

8. The microLED-based communication system of claim 7, wherein the portion of the assembly fixture comprises a circumferential wall.

9. The microLED-based communication system of claim 1, wherein the first end faces of the fiber elements are fixed in position relative to one another by adhesive.

10. The microLED-based communication system of claim 1, further comprising a frame, the frame configured to maintain the first end faces of the fiber elements fixed in position relative to one another.

11. The microLED-based communication system of claim 10, wherein the frame includes a circumferential wall, with the circumferential wall configured to maintain the first end faces of the fiber elements fixed in position relative to one another.

12. The microLED-based communication system of claim 10, wherein the frame includes a circumferential wall and interior walls extending between different sides of the circumferential wall, with the circumferential wall and the interior walls configured to maintain the first end faces of the fiber elements fixed in position relative to one another.
